(19) United States
(12) Patent Application Publication
(10) Pub. No.: US 2005/0269020 A1
(43) Pub. Date: Dec. 8, 2005

(54) Method for producing a laminate polarizing plate and an optical member using thereof

(75) Inventor: Yoshiki Matsuoka, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/136,378

(22) Filed: May 25, 2005

(30) Foreign Application Priority Data
May 25, 2004 (JP) 2004-154238

(51) Int. Cl. B32B 31/00

(52) U.S. Cl. 156/235

(57) ABSTRACT

A method for producing a laminate polarizing plate comprising a first phase retarder film and a second phase retarder film, wherein the first phase retarder film comprises an in-plane oriented transparent resin film having an adhesive layer on its surface, the second phase retarder film has at least one coating layer with refractive index anisotropy, and the second phase retarder film is on the adhesive layer is provided. The method comprising: a first step of forming the coating layer on a transfer substrate, followed by laminating an opposite surface of the coating layer to the transfer substrate on the adhesive layer of the first phase retarder film; and a second step of peeling the transfer substrate from the coating layer along with forming a second adhesive layer on the surface of the coating layer from which the transfer substrate has been peeled.

### BACKGROUND OF THE INVENTION

1. Field of the Invention

The present invention relates a laminate polarizing plate effective to improve viewing angle characteristics of liquid crystal displays, a method of producing the same and a liquid crystal display comprising the same.

2. Description of the Related Art

Liquid crystal displays which have characteristics of low power consumption, low drive voltage, light weight and flat panel, rapidly spread to devices displaying information such as cellular phones, handheld terminals, monitors for computer and televisions. On account of development of liquid crystal cell technologies, liquid crystal displays having various modes are proposed and it is getting to solve the problems of liquid crystal display relating response speed, contrast and narrow viewing angle. The liquid crystal displays, however, are still pointed out on the problem of their narrower viewing angle compared with cathode ray tubes (CRT); hence, various attempts have been done to expand their viewing angle.

As one of liquid crystal displaying methods to improve the viewing angle, for example, Japanese Patent No. 2548979 discloses a vertical-alignment mode nematic type liquid crystal display (VA-LCD). The vertical-alignment mode passes light through liquid crystal layer without changing polarization thereof due to liquid crystal molecules being aligned vertically against substrate in non-driving state. Therefore, by placing linear polarizing plates on and under a liquid crystal panel in a manner of their polarization axes being orthogonal each other, it is achieved to obtain almost complete black indication giving high contrast ratio when being viewed from front side.

However, the vertical-alignment mode liquid crystal displays equipping only polarizing plates to a liquid crystal cell, when viewed from inclined directions, remarkably decreases contrast by light leakage due to deviation of viewing angle to the equipped polarizing plates from 90°, and generating birefringence on rod-like liquid crystal molecules in the cell.

To depress this light leakage, it is necessary to dispose optical compensation films between a liquid crystal cell and linear polarizing plates; for this purpose, conventionally applied methods include the method that each one of biaxial phase retarder films being independently disposed between a liquid crystal cell and, respective upper and lower polarizing plates; the method that each one of an uniaxial phase retarder film and a completely biaxial phase retarder film being independently disposed respectively on and under a liquid crystal cell; or the method that both of an uniaxial phase retarder film and a completely biaxial phase retarder film being co-disposed at one side of a liquid crystal cell. JP-A No. 2001-109009 discloses that, in a vertical-alignment mode liquid crystal display, each of an a-plate (positive uniaxial phase retarder film) and a c-plate (completely biaxial phase retarder film) is independently disposed between a liquid crystal cell, and respective upper and lower polarizing plates.

The positive uniaxial phase retarder film is a film of which ratio R₀/R′ of an in-plane retardation value (R₀) to a retardation value in a thickness direction (R′) is approximately 2; and the completely biaxial phase retarder film is a film of which in-plane retardation value (R₀) is nearly zero. When letting nₓ to the refractive index of in-plane slow axis of film, n_{y} to the refractive index of in-plane fast axis of film, nz to the refractive index in thickness direction, and d to the film thickness, the in-plane retardation value R₀ and the retardation value in a thickness direction R′ are respectively defined by the following formula (I) and (II).
R₀=(nₓ−n_{y})×d (I)
R′=[((nₓ+n_{y})/2−n₂)×d (II)

Due to n_{z}≈n_{y} in a positive uniaxial phase retarder film, it results R₀/R′≈2. Even in a uniaxial phase retarder film, R₀/R′ varies in a range approximately 1.8 to 2.2 due to fluctuation of film elongation conditions. Due to nₓ≈n_{y} in a completely biaxial phase retarder film, it results R₀≈0. Since the completely biaxial phase retarder film is a film of which refractive index is different (or smaller) only in a thickness direction, it has a negative uniaxial phase retardation, and is alternatively called a film having an optical axis in normal line or, as aforementioned, a c-plate. The biaxial phase retarder film attains nₓ>n_{y}>n_{z}.

Above described methods such that each of a biaxial phase retarder film being independently disposed between a liquid crystal cell and, respective upper and lower polarizing plates, each of an uniaxial phase retarder film and a completely biaxial phase retarder film being independently disposed respectively on and under a liquid crystal cell, or both of an uniaxial phase retarder film and a completely biaxial phase retarder film being co-disposed at one side of a liquid crystal cell, are performed by a complex production procedures or economically disadvantaged, or leading to a remarkable increase of the total thickness of optical film disposed on upper and lower the liquid crystal cell.

It is known that a layer exhibiting refractive index anisotropy is formed by coating some kinds of solutions or dispersions. For example, JP-A No. H07-191217 discloses that a coating solution dissolving a discotic liquid crystal in an organic solvent is coated on a transparent support film, followed by aslant aligning and then fixing the liquid crystal to obtain an optically anisotropic element, and the optically anisotropic element is disposed at least one side of a polarizer to form an elliptic polarizing plate. U.S. Pat. No. 6,060,183 (corresponding to JP-A No. H10-104428) discloses that a phase retarder film is formed by a layer containing an organic modified clay composite able to disperse in an organic solvent. WO94/24191 (corresponding to JP-A No. H08-511812) discloses that a polyimide film prepared from a soluble polyimide solution is used as a negative birefringent anisotropic layer for liquid crystal display devices. WO96/11967 (corresponding to JP-A No. H10-508048) discloses that a negative birefringent film prepared from a rigid chain polymer comprising polymers exhibiting a negative birefringent anisotropy such as a polyamide, a polyester, a poly(amide-imide) or a poly(ester-imide) is applied to liquid crystal displays. Moreover, U.S. Pat. No. 5,196,953 (corresponding to JP-A No. H05-249457) discloses that a multi-layered thin film alternately laminated with materials having different refractive index is used as an optical compensation layer for liquid crystal displays.

JP-A No. 2004-4150 (corresponding to U.S. 2003/0219549 A1) discloses the laminated phase retarder film showing biaxial orientation as a whole, which is obtained by laminating a coating layer having refractive index anisotropy on a transparent resin substrate having in-plane orientation.

### SUMMARY OF THE INVENTION

The inventors of the present invention have diligently studied to develop a laminate polarizing plate which achieves simple constitution, simple production procedures, cost reduction and thin film, for applying to vertical-alignment mode liquid crystal displays to obtain well viewing angle. Besides, the inventors have studied advantageous methods for producing a laminate polarizing plate which is composed of a first phase retarder film being in-plane orientation and a second phase retarder film including a coating layer, like the one disclosed in JP-A No. 2004-4150. Consequently, the inventors have found that a laminate polarizing plate having excellent viewing angle and thin thickness can be produced by transferring and laminating a second phase retarder film comprising a coating layer on a first phase retarder film comprising a transparent resin film having in-plane orientation. Furthermore, when other optical layer is also laminated on the laminate polarizing plate, the obtained one still exhibits excellent optical characteristics; and achieved the present invention.

One of objects of the invention is to provide a cost advantageous method for producing a laminate polarizing plate excellent in uniformity, showing biaxial orientation as a whole and capable of applying an excellent optical characteristics originated from biaxial orientation to wide range. Another object of the invention is to provide a method for producing an optical member preferably employed to liquid crystal displays, by laminating other optical layer on the laminate polarizing plate.

The present invention provides a method for producing a laminate polarizing plate comprising a first phase retarder film and a second phase retarder film, wherein the first phase retarder film comprises an in-plane oriented transparent resin film having an adhesive layer on its surface, the second phase retarder film has at least one coating layer with refractive index anisotropy, and the second phase retarder film is on the adhesive layer, the method comprising:
a first step of forming the coating layer on a transfer substrate, followed by laminating an opposite surface of the coating layer to the transfer substrate on the adhesive layer of the first phase retarder film; and
a second step of peeling the transfer substrate from the coating layer along with forming a second adhesive layer on the surface of the coating layer from which the transfer substrate has been peeled.

The first phase retarder film may be, for example, in a range of 30 to 300 nm of its in-plane retardation value R₀, and preferably, be a ¼-wavelength retarder plate.

In the laminate polarizing plate, a coating layer having refractive index anisotropy may be, for example, constituted with a liquid crystalline compound or a cured liquid crystalline compound. The coating layer having refractive index anisotropy may be also constituted with a layer containing an organic modified clay composite which being able to disperse in an organic solvent. The layer containing an organic modified clay composite may include, in addition to the organic modified clay composite, a binder resin, for example, such as methacrylic resins, urethane resins and polyester resins. In this case, it is advantageous that the binder resin has a glass transition temperature of equal to or less than a room temperature. Furthermore, the coating layer having refractive index anisotropy may be constituted by a polyimide film prepared from a soluble polyimide solution, or by a layer containing a rigid chain polymer including polymers exhibiting a negative birefringent anisotropy such as a polyamide, a polyester, a poly(amide-imide) or a poly(ester-imide). The coating layer having refractive index anisotropy may be still more constituted by a multi-layered thin film alternately laminated with materials having different refractive index.

The transfer substrate used in the above method is preferably subjected to a treatment of mold release on a surface which the coating layer being formed on, wherein a water contact angle of the surface subjected to the treatment of mold release is 90 to 130°. In the second step of peeling the transfer substrate from the coating layer along with forming a second adhesive layer on the surface of the coating layer from which the transfer substrate has been peeled, it is advantageous that the second adhesive layer is formed under the condition that an increase of a water contact angle of the surface of the coating layer after removing the transfer substrate, is not more than 15° in comparison with a water contact angle of the exposed surface of the formed coating layer.

Thus obtained laminate polarizing plate may be applied to an optical member by means of laminating an optical layer exhibiting another optical function, for example, a polarizing plate. The invention also provides a method for producing an optical member, wherein the method includes: preparing the first phase retarder film comprising an in-plane oriented transparent resin film having an adhesive layer on its surface; separately preparing a second phase retarder film by forming at least one coating layer having refractive index anisotropy on a transfer substrate; laminating an opposite surface of the coating layer to the transfer substrate on the adhesive layer of the first phase retarder film; and followed by peeling the transfer substrate from the coating layer along with forming a second adhesive layer on the surface of the coating layer from which the transfer substrate has been peeled, to produce a laminate polarizing plate having layers of first phase retarder film/adhesive layer/second phase retarder film/second adhesive layer; and thereafter laminating an optical layer which exhibits another optical function, on the laminate polarizing plate. When a polarizing plate is employed as the another optical layer, the polarizing plate is usually laminated on the side of the first phase retarder film of the laminate polarizing plate.

### BRIEF DESCRIPTION OF THE DRAWING

FIG. 1: A schematic sectional view exemplifying outline of a production process of the laminate polarizing plate.

FIG. 2: A schematic sectional view exemplifying outline of a first step when a laminate polarizing plate is produced in rolled form.

FIG. 3: A schematic sectional view exemplifying outline of a second step when a laminate polarizing plate is produced in rolled form.

FIG. 4: A schematic sectional view exemplifying outline of consecutively carrying out a first step and a second step to produce a laminate polarizing plate in rolled form.

FIG. 5: A schematic sectional view exemplifying outline of an example of an optical member including a laminate polarizing plate and a polarizing plate.

10 - - - Laminate polarizing plate
11 - - - First phase retarder film
12 - - - Adhesive layer
13 - - - Retarder film with adhesive
14 - - - Release film of first phase retarder film
16 - - - Semi-finished product
17 - - - Semi-finished product after peeling transfer substrate
20 - - - Transfer substrate
21 - - - Second phase retarder film including coating layer
22 - - - Second adhesive layer
23 - - - Release film of second adhesive layer
24 - - - Film with an adhesive
26 - - - Polarizing film
27 - - - Third adhesive layer
28 - - - Optical member (an example of an optical member with polarizing film)
30 - - - Transfer substrate roller
32 - - - Coating layer coater
34 - - - Coating layer drying zone
36 - - - First phase retarder film roller
38 - - - Release film rolling in roller
40 - - - Semi-finished product roller
41 - - - Semi-finished product turning roller
43 - - - Transfer substrate peeling off roller
44 - - - Transfer substrate rolling in roller
45 - - - Film with an adhesive roller
46 - - - Adhesive coater
47 - - - Adhesive drying zone
48 - - - Release film roller
50 - - - Product roller
   Preferable Embodiment of the Invention

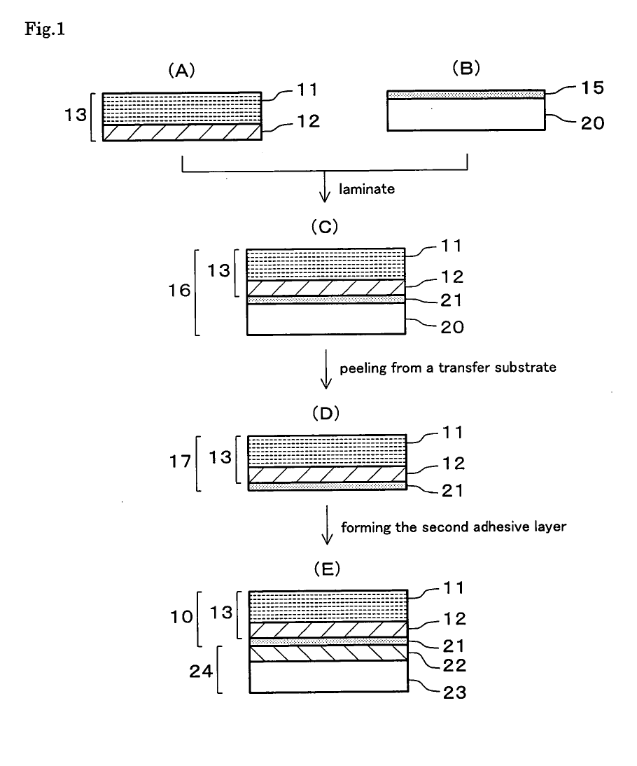

The present invention is explained in detail as follows by appropriately referring the drawings. FIG. 1 is a schematic sectional view exemplifying outline of production of a laminate polarizing plate of the invention. Referring the Figure, the method for producing a laminate polarizing plate is explained.

As shown in FIG. 1 (A), a first phase retarder film 11 having an adhesive layer 12 on its surface is prepared. The layers forming the adhesive layer 12 on the first phase retarder film 11, is called an adhesive retarder film 13. Separately, as shown in FIG. 1 (B), a coating layer having refractive index anisotropy 21 is formed on a transfer substrate 20. The coating layer 21 becomes a second phase retarder film. The coating layer 21 may be constituted with a single layer or a multilayer having at least 2 layers. After thus finishing formation of the coating layer 21 on the transfer substrate 20, an opposite surface of the coating layer 21 to the transfer substrate (an exposed surface of the coating layer 21), shown in FIG. 1 (B), is laminated on the adhesive layer 12 of the first phase retarder film 11 shown in FIG. 1 (A), to form a semi-finished product 16 having a layer structure, as shown in FIG. 1 (C), of first phase retarder film 11/adhesive layer 12/coating layer (second phase retarder film) 21/transfer substrate 20.

Thereafter, by peeling the transfer substrate 20 away from the semi-finished product 16 shown in FIG. 1 (C); after the transfer substrate is peeled off, a semi-finished product 17 is formed in a layer structure, as shown in FIG. 1 (D), of first phase retarder film 11/adhesive layer 12/coating layer (second phase retarder film) 21; along with forming a second adhesive layer 22 on the surface of the second phase retarder film 21 including the coating layer from which the transfer substrate has been peeled from, to produce a laminate polarizing plate 10 having a layer structure, as shown in FIG. 1 (E), of first phase retarder film 11/adhesive layer 12/coating layer (second phase retarder film) 21/second adhesive layer 22. The second adhesive layer 22 is usually covered with a releasing film 23 to protect the surface thereof, and the film is removed away therefrom before the adhesive layer being adhered to other members such as liquid crystal cells. In this case, an adhesive film 24 in which the second adhesive layer 22 is formed on the release film 23, may be adhered on the surface of the second phase retarder 21 including the coating layer from which transfer substrate was peeled, or an adhesive may be coated on the surface of the second phase retarder film 21 including the coating layer from which transfer substrate was peeled, followed by being dried to form the second adhesive layer 22. If applying the latter, the release film 23 may be laminated on the second adhesive layer 22 which has been already prepared.

As mentioned above, in the invention, the first step and the second step are carried out in this order, and in the second step the peeling-away procedure of the transfer substrate 20 and the forming procedure of the second adhesive layer are consecutively carried out; wherein the first step is that the coating layer 21 is formed on the transfer substrate 20, followed by laminating the adhesive layer 12 of the first phase retarder film 11 on the exposed surface of the coating layer 21; and the second step is that the transfer substrate 20 on the semi-finished product 16 thus obtained is peeled off from the coating layer 21 along with forming the second adhesive layer 22 on the surface of the coating layer 21 from which the transfer substrate was peeled. Employment of this method can effectively suppresses generation of phase retardation irregularities, air bubbles left in adhered parts and foreign objects in the laminate polarizing plate obtained. In FIG. 1, (A) to (C) correspond to the fist step, and (D) and (E) correspond to the second step.

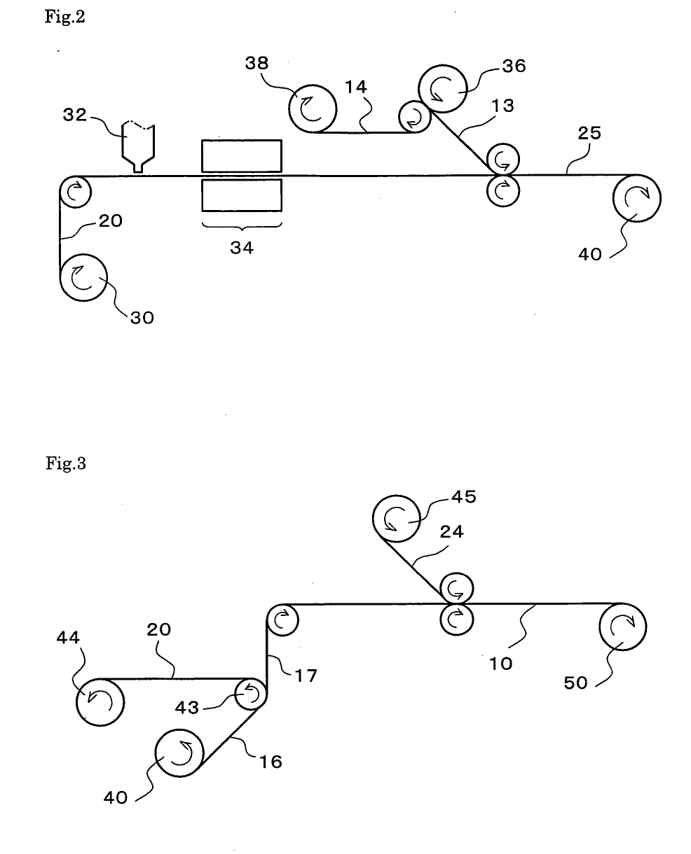

Further specific embodiment of the first step is explained with reference to FIG. 2. FIG. 2 is a side view exemplifying outline of the first step, when the laminate polarizing plate is produced in a rolled form, of from forming a coating layer on a transfer substrate to laminating a first phase retarder film on the coating layer. By referring FIG. 2, a surface of the transfer substrate 20 which is unrolled out from a transfer substrate unrolling out roller 30, is coated with a coating solution for coating layer by a coater 32, followed by being dried during going through a drying zone 34, and then being subjected to adhering to an adhesive retarder film (first phase retarder film) 13. Since the adhesive retarder film 13 is usually supplied in a form that a peelable release film is pre-adhered on the surface of the adhesive layer, a release film 14 is at first peeled off from the adhesive retarder film 13 which is unrolled out from a first phase retarder film unrolling out roller 36, followed by being rolled in to a release film rolling in roller 38. Then, a surface exposing the adhesive layer of the adhesive retarder film 13, is adhered on the surface of the coating layer formed on the transfer substrate described above, this results a semi-finished product 16 having a layer structure of first phase retarder film/adhesive layer/coating layer (second phase retarder film)/ transfer substrate, followed by being rolled in a semi-finished product roller 40.

When coating layers are formed on a surface of a substrate and the substrate with coating layer is laminated on other members, a general method is a method in which a film for protection is adhered on an air-exposed surface of the coating layer, followed by being rolled in, and then the rolled film is further rolled out to be adhered to other members along with the protection film being peeled off. The first step of the present invention has advantages not only in production cost due to reduction of processing steps, but in quality of semi-finished product 16 due to suppressing incomplete peeling of the protection film to leave a part of the protection film on the coating layer, and to suppressing foreign object defects derived from protection film.

The second step is explained with reference to FIG. 3. FIG. 3 is a side view exemplifying outline of the second step, when the laminate polarizing plate is produced in a rolled form, of from peeling the transfer substrate away from the semi-finished product to forming a second adhesive layer on the surface of the coating layer from which the transfer substrate was peeled. The step is explained referring to FIG. 3; the semi-finished product 16 once rolled in the semi-finished product roller 40 in the first step shown in FIG. 2, is again unrolled out from the same roller 40, followed by being peeled off from a transfer substrate 20 by a transfer substrate peeling off roller 43; and then a surface of the coating layer of the semi-finished product 17 which is exposed by peeling away the transfer substrate, is supplied with an adhesive film 24 unrolled out from a adhesive film roller 45 in order to adhere to the adhesive layer side of the adhesive film, followed by the coating layer and the adhesive film being adhering each other to obtain objected laminate polarizing plate 10 and then being rolled in a product roller 50. The transfer substrate 20 peeled off from the semi-finished product 16 is rolled in a transfer substrate rolling in roller 44. Although the figure shows a case that the adhesive film 24 is employed to form the second adhesive layer, as aforementioned, the adhesive may be directly coated on the coating layer.

Thus, in the second step, the transfer substrate 20 is peeled off from the semi-finished product 16 along with forming a second adhesive layer 22 on the surface of the second phase retarder film 21 including the coating layer, that is, the second step is adhesive process. Through these first and second steps, the laminate polarizing plate disposed in the order of first phase retarder film/adhesive/second phase retarder film/second adhesive, is obtained.

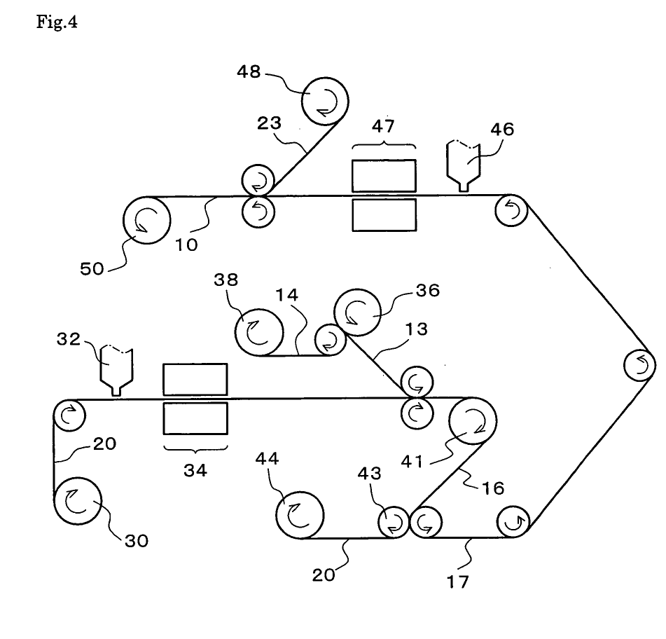

The first step shown in FIG. 2 and the second step shown in FIG. 3 may be consecutively carried out. The example of this is illustrated in FIG. 4 as a schematic side view. In FIG. 4, parts corresponding to the part exhibited in FIGS. 2 and 3 are represented by the same signs used therein, and detail explanations thereabout are omitted. In this example, the surface of the transfer substrate 20 unrolled out from the transfer substrate unrolling out roller 30, is coated with a coating solution for the coating layer by the coater 32, followed by passing through the drying zone 34 to be dried, and then the resultant coated side thereof is adhered to the adhesive layer side of the adhesive polarizing film 13 which is unrolled out from the first phase retarder film unrolling out roller 36 and then peeled off the release film 14; consequently, the semi-finished product 16 having a layer structure of first phase retarder film/adhesive layer/coating layer (second phase retarder film)/transfer substrate, is obtained. The procedures described here are same to that of the first step shown in FIG. 2.

After the above procedures, the semi-finished product 16 is passed through a semi-finished product turning roller 41 without being rolled in, followed by peeling the transfer substrate off by a transfer substrate peeling off roller 43, and the peeled-off transfer substrate 20 is rolled on a rolling in roller 44. On the other hand, the semi-finished product 17 peeled off from the transfer substrate, is coated on the coating surface thereof with an adhesive by an adhesive coater 46, followed by being dried during passing through a drying zone 47; and then the resultant coated surface is adhered with a release film 23 unrolled out from a release film roller 48 to obtain the objected laminate polarizing plate 10, followed by being rolled in a product roller 50. While, in this example, in order to form the second adhesive layer, a direct coating-drying method employing the adhesive coater 46 and the drying zone 47 is illustrated, the method of applying the adhesive film as shown in FIG. 3, may be employed.

In FIGS. 2 to 4, curled arrows indicate a direction of rotation of rollers.

If the coating layer 21 is left for long time under contacting with the transfer substrate 20, the mould releasing agent on the transfer substrate 20 often migrates to the coating layer 21, and this results in an increase of a water contact angle of the surface of the coating layer 21 after peeled off the transfer substrate 20. In view of adhesive ability between the surface of the coating layer 21 after peeled off the transfer substrate 20 and the second adhesive layer 22, the peeling-off and adhesive-coating process in the second step is preferably carried out under such condition that an increase of a water contact angle of the surface of the coating layer 21 after peeled off the transfer substrate, is within 15°, preferably within 10°, in comparison with a water contact angle of the exposed surface of the coating layer 21 to air when the coating layer 21 is formed on the transfer substrate 20 (refer to FIG. 1 (B)). For this purpose, it is preferable to shift to the second step as soon as possible after finishing the first step. Since mould releasing agent may migrate from the transfer substrate 20 to the coating layer 21 by the rolling pressure loaded on the semi-finished product 16 during its rolling process, employment of sidetape for rolling the semi-finished product 16 is also a preferable method to inhibit the migration. Furthermore, when the adhesive process is provided for the coating layer 21 after peeled off the transfer substrate 20, subjecting corona treatment to either surface of the coating layer 21 or the second adhesive layer 22 is also a preferable method.

The first phase retarder film 11 including transparent resin film is not limited as long as being excellent in transparency and uniform in quality; preferably used are stretched films of thermoplastic resins in a view of easily producing the film. The thermoplastic resins include cellulose resins, polycarbonate resins, polyarylate resins, polyester resins, acrylic resins, polysulfone resins, and cyclic-polyolefin resins. Of these, cellulose resins, polycarbonate resins and cyclic-polyolefin resins are preferable due to cheap and uniform quality films being easily obtainable.

Methods for producing a primary film for stretching may be appropriately selected from a solvent casting method, a precision extruding method which achieves small residual stress in the obtained films, and the like. Stretching methods are not particularly limited, applicable are a vertical-traverse stretching by rolls method, a tenter traversed uniaxial stretching method, a biaxial stretching method and the like, which achieve homogeneous optical characteristics of the obtained film. The film thickness of the first phase retarder film is not particularly limited, and the thickness usually is in a range of about 50 to 500 μm. The retardation value dependency on wavelength of the first phase retarder film is also not particularly limited, and preferable is a wavelength dependency having retardation distribution in which retardation values decrease along with shortening wavelength.

An in-plane retardation value R₀ of the first phase retarder film 11 is appropriately selected from a range of 30 to 300 nm depending on application of the laminate polarizing plate. For example, when the laminate polarizing plate is applied to relatively small size liquid crystal displays such as cellular phones and handheld terminals, preferable laminate polarizing plate is ¼ wavelength retarder plate. Since monoaxial stretched films are usually employed to the ¼ wavelength retarder plate, the ratio R₀/R′ of in-plane retardation value R₀ to retardation value in the thickness direction R′ is around 2, for example in a range of 1.8 to 2.2. On the other hand, when the laminate polarizing plate is applied to relatively large size liquid crystal displays such as monitors for desk-top type personal computers and televisions, preferable laminate polarizing plate is a phase retardation film of which an in-plane retardation value R₀ is in a range of 30 to 300 nm with slightly having biaxial orientation. The phase retardation film having biaxial orientation has a correlation of nₓ>n_{y}>n_{z} in refractive indices of nₓ, n_{y} and n_{z} of three axes of the film describe above, and the R₀/R′ of in-plane retardation value R₀ to retardation value in the thickness direction R′ is more than 0 and less than 2.

The coating layer applied to the second phase retarder film 21 is not particularly limited as long as having negative birefringent anisotropy in the thickness direction thereof, for example, the followings can be used.
a layer containing a liquid crystalline compound itself or a cured liquid crystalline compound;
a layer containing at least one organic modified clay composite able to disperse in an organic solvent as disclosed in the above described U.S. Pat. No. 6,060,183 (corresponding to JP-A No. H10-104428);
a layer including a polyimide film prepared from a soluble polyimide solution as disclosed in the above described WO94/24191 corresponding to JP-A No. H08-511812);
a layer including rigid chain polymers such as a polyamide, a polyester, a poly(amide-imide) or a poly(ester-imide) which exhibiting a negative birefringent anisotropy, as disclosed in the above described WO96/11967 corresponding to JP-A No. H10-508048); and
a layer including a multi-layered thin film alternately laminated with materials having different refractive index as disclosed in the above described U.S. Pat. No. 5,196,953 (corresponding to JP-A No. H05-249457).

When a layer containing a liquid crystalline compound itself or a cured liquid crystalline compound, is employed as the coating layer, the liquid crystalline compound shall be aligned to exhibit a negative birefringent anisotropy in the direction of thickness thereof. The aligned formation varies depending on the kind of liquid crystalline compound employed; for example, preferably applied alignments for exhibiting a negative birefringent anisotropy in the direction of thickness are, in the case of a discotic liquid crystal compound, homeotropic alignment in which disc faces oriented upward, or in the case of a rod-like nematic liquid crystal compound, super twisted alignment of equal to or more than 270°. Methods of aligning a liquid crystalline compound are not limited, conventional ones can be applicable such as employing oriented films, rubbing, addition of chiral dopant and light radiation and the like. Furthermore, after a liquid crystalline compound being aligned, the liquid crystalline compound may be cured to fix the alignment, or leave liquid crystallinity thereof to retain functions such as temperature compensation and the like.

When a layer containing at least one organic modified clay composite able to disperse in an organic solvent as described above, is employed as the coating layer, if the transfer substrate 20 applied to form a film is a flat plate, a unit crystalline layer of the organic modified clay composite aligns its laminar structure parallel to the surface of the flat plate and random in its own plane. Consequently, the layer, without specific alignment treatment, exhibits a refractive index structure that the in-plane refractive index is larger than the refractive index of the thickness direction.

The organic modified clay composite, as described, is a composite of an organic compound and a clay mineral, more specifically, for example, a combined substance of a clay mineral having laminar structure and an organic compound. The clay minerals having laminar structure includes a smectite group or a swellable mica, of which positive ion exchangeability enables to combine with organic compounds. Among of them, the smectite group is preferably employed due to its excellent transparency. Examples belonging to the smectite group are hectorite, montmorillonite, bentonite and the like, substituteds thereof, derivatives thereof and mixtures thereof. Among those, the synthesized is preferable due to little contamination with impurities and excellent transparency. The synthetic hectorite whose particle diameter is controlled to be small is particularly preferably used due to its ability to suppress scattering of visible lights.

The organic compounds combined with clay minerals include compounds capable of reacting with oxygen atoms and hydroxyl groups of the clay mineral or an ionic compounds capable of exchanging with exchangeable cations; which are not particularly limited as long as the resultant organic modified clay composite can be swelled or dispersed in an organic solvent, specifically included are nitrogen-containing compounds and the like. The nitrogen-containing compound includes, for example, a primary, a secondary or a tertiary amine, a quaternary ammonium compound, urea, hydrazine, and the like. Of these, the quaternary ammonium compound is preferable due to its ability to easily exchange cations.

The organic modified clay composites may be used by combining two or more kinds thereof. Suitable commercialized organic modified clay composite includes the composite compound of synthetic hectorite and a quaternary ammonium compound manufactured by CO-OP Chemical Co., LTD. in the trade name of Lucentite STN or Lucentite SPN.

The organic modified clay composites is preferably used in combination with a resin as binder from the view points of easiness of forming coating layer on a transfer substrate, expressing ability of optical characteristics, mechanical properties and the like. The binders used with the organic modified clay composites is preferably the one soluble to organic solvents such as toluene, xylene, acetone, ethylacetate and the like, particularly preferably the one of which glass transition temperature being equal to or lower than a room temperature (preferably at least 20° C. lower than a room temperature). The binders having hydrophobic property are also preferable to obtain well moisture and temperature resistance and well handling ability which being required when the compound polarizing plate is applied to liquid crystal displays. Those preferable binders include polyvinylacetal resins such as polyvinylbutyral and polyvinylformal; cellulose resins such as cellulose acetate butyrate; acrylic resins such as butylacrylate; methacrylic resins, urethane resins, epoxy resins, polyester resins and the like. Among of them, the acrylic resins are particularly preferably applied. Those resins may be a polymerized resin, or polymerized with monomers or oligomers thereof by heat or ultra violet light in film processing procedure. Furthermore, the plural thereof may be used in mixture.

Commercial resins used as suitable binder include an aldehyde-modified polyvinylalcohl resin manufactured by DENKA Co., Ltd. in the trade name of Denka Butyral #3000-K, acrylic resin manufactured by TOAGOSEI Co., Ltd. in the trade name of Aron S1601, urethane resin based on isophoronediisocyanate manufactured by SUMIKA BAYER URETHANE Co., Ltd. in the trade name of SBU lacquer 0866, and the like.

A ratio of the organic modified clay composite dispersible to organic solvents to the binder, is preferably in a range of from 1:2 to 10:1 in terms of the weight ratio of the former (the organic modified clay composite): the latter the binder, from the viewpoint of improving mechanical characteristics such as prevention of fracture of a layer including the organic modified clay composite and the binder.

The organic modified clay composite is coated on the transfer substrate in a state dispersed in an organic solvent. When a binder being used simultaneously, the binder is also dispersed and dissolved together in the organic solvent. A concentration of solid in the dispersed solution is not limited as long as gellation or turbidity of the prepared dispersed solution is occurred to the extent not causing troubles in practical usage; usually applied range is 3 to 15% by weight in terms of the total of the solid concentration of the organic modified clay composite and the binder. Since the optimal solid concentration varies depending on the kind or the composition ratio of organic modified clay composites or binders employed respectively, it is determined on each case of the composition. Various additives such as a viscosity adjustor for improving layer formability in case of forming a layer on a transfer substrate, a crosslinking agent for further improving the hydrophobic nature and/or durability, and the like, may also be added.

As the coating layer, it is also possible to apply the layer including a polyimide film prepared from a soluble polyimide solution as disclosed in WO 94/24191, or the layer including rigid chain polymers such as a polyamide, a polyester, a poly(amide-imide) or a poly(ester-imide) which exhibiting a negative birefringent anisotropy as disclosed in WO 96/11967. Those soluble polymers exhibit a negative birefringent anisotropy due to the main chain thereof being aligned parallel to the surface of release film through self-aligning process when being cast on a transfer substrate, and the degree of refractive index anisotropicity can be also adjusted by changing linearity or rigidity of the main chain thereof besides by changing thickness of the coating layer.

When a layer including a multi-layered thin film alternately laminated with materials having different refractive index as disclosed in U.S. Pat. No. 5,196,953, is employed as the coating layer, thickness and refractive index of each layer is designed to obtain required negative birefringent anisotropy according to the disclosure therein.

The thickness of the coating layer is not particularly limited, may be in the range that the in-plane retardation value R₀ is 0 to 10 nm and the retardation value in the thickness direction R′ is 40 to 300 nm. It is not preferable that the in-plane retardation value R₀ exceeds 10 nm, because the exceeded value is not neglectable and deteriorates a negative uniaxiality in the thickness direction. Since the refractive index anisotropy in the thickness direction which is necessary for the second phase retarder film 21, varies depending on the case of usage, the retardation value in the thickness direction R′ is appropriately selected from a range of 40 to 300 nm according to the objected application thereof, especially to the characteristics of a liquid crystal cell. The retardation value in the thickness direction R′ is advantageously about 50 to 200 nm.

The refractive index anisotropy in the thickness direction is represented by the retardation value in the thickness direction R′ which being defined by the formula (II) described above; and can be calculated from a retardation value R₄₀ which is measured in 40° inclined state by applying the in-plate slow axis as an inclined axis, and the in-plane retardation value R₀. The retardation value in the thickness direction R′ defined by the formula (II) can be calculated as follows; using the in-plane retardation value R₀, the retardation value R₄₀ measured in 40° inclined state by applying the in-plate slow axis as an inclined axis, the film thickness d and the average refractive index of film n₀, the nₓ, n_{y} and n_{z} are obtained from the following formulas by numerical computation, and the results of the numerical computation are substituted in the aforementioned formula (II).
R₀=(nₓ□n_{y})×d (III)
R₄₀=(nₓ□n_{y}′)×d/cos (f) (IV)
(nₓ+n_{y}+n_{z})/3=n₀ (V),
wherein
f=sin⁻¹[ sin(40°)/n₀]
n_{y}′=n_{y}×n_{z}/[n_{y}²×sin²(f)+n_{z}²×cos²(f)]^{1/2}

If at least one coating layer having refractive index anisotropy which being formed on a transfer substrate, is once transferred on a glass plate by being interposed with an adhesive, the R₀ and R₄₀ of the coating layer (a phase retarder film) can be directly obtained; consequently, according to the results obtained, the retardation value in the thickness direction R′ can be calculated by the above procedure.

A transfer substrate 20 used for forming a coating layer 21 (refer to FIG. 1 (B)) is a pre-treated film to easily peel off a layer formed on the surface thereof, the film is commercially available, generally, such as resin films of polyethylene terephthalate and the like of which surface is processed with treatment of mould release by coating mould release such as a silicone resin, a fluoric resin and the like. In order to form the coating layer 21 on the transfer substrate 20, a water contact angle of the transfer substrate 20 is preferably 90 to 130°, the water contact angle is further preferably equal to or more than 100° or equal to or less than 120°. If the water contact angle is less than 90°, the peel-off ability of the transfer substrate 20 is not sufficient, tending to cause defects such as phase retardation irregularity and the like in the phase retarder film including the coating layer 21. If the water contact angle is more than 130°, an un-dried coating solution on the transfer substrate 20 often exhibits repelling property, resulting in-plane phase retardation irregularity. The water contact angle mentioned here means a contact angle with a water used as liquid, and means that the larger the angle (upper limit value being 180°) is, the less wetting ability is.

Coating methods employed to form the coating layer 21 in the first step of the invention, are not particularly limited, various conventional coating methods can be employed such as a direct gravure method, a reverse gravure method, a die coating method, a comma coating method, a bar coating method and the like. Of these, the comma coating method, the die coating method without applying back-up roll, and the like are preferably employed due to excellent thickness precision.

The adhesive which is applied to the adhesive layer 12 formed on the surface of the first phase retarder film 11 shown in FIG. 1 (A), and to the second adhesive layer 22 formed on the surface of the coating layer 21 from which the transfer substrate was peeled in the second step as shown in FIG. 1 (E), includes the one having base polymers such as acrylic resins, silicone resins, polyesters, polyurethanes, polyethers and the like. Of those, the preferably applied is the one selected from the adhesives, like acrylic resin adhesives, having properties of excellent optical transparency, retaining appropriate wettability and cohesive power, excellent adhesive ability to substrate, weather and temperature resistances, not causing exfoliation problems such as floating up, peeling off or the like under heated or humid conditions. In the acrylic resin adhesives, the useful base polymer is an acrylic copolymer resin having a weight average molecular weight of equal to or more than 100 thousand which being polymerized by blending methacrylic acid alkyl esters and acrylic monomers containing a functional group to make the glass transition temperature of the resultant copolymer being preferably equal to or less than 25° C., more preferably equal to or less than 0° C.; the methacrylic acid alkyl esters which having an alkyl group having carbon atoms of equal to or less than 20 such as a methyl group, an ethyl group, a butyl group and the like; and the acrylic monomers containing functional group which including a methacrylic acid, a methacrylic acid hydroxylethyl and the like. Each of thickness of the adhesive layers 12 and 22 is usually respectively about 15 to 30 μm.

Thus obtained laminate polarizing plate may form an optical member by further laminating thereon an optical layer which exhibits other optical function other than phase retarding functions. The optical layer laminated to the laminate polarizing plate for the purpose of forming an optical members, includes materials conventionally applied for formation of liquid crystal displays, for example, such as polarizing plates and brightness improvement films.

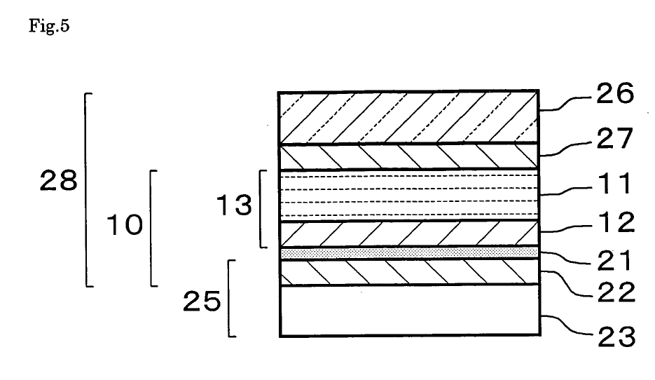

Combination of the laminate polarizing plate of the present invention and polarizing plates may be used as linear polarizing plates or circular polarizing plates which have viewing angle compensation function. When it is used as a linear polarizing plate, it is preferable that the first phase retarder film is placed on the polarizing plate so that the slow axis of the first phase retarder film is orthogonally across the absorption axis of the polarizing plate. Alternatively, when it is used as a circular polarizing plate, it is preferable that the first phase retarder film is placed on the polarizing plate so that the slow axis of the first phase retarder film is across the absorption axis of the polarizing plate in a pre-determined angle. FIG. 5 shows an example of the optical member 28 in which a polarizing plate 26 is laminated through the third adhesive layer 27 on the side of the first phase retarder film 11 of the laminate polarizing plate 10 (the release film 23 is disposed at outer side of the second adhesive layer 22 thereof) as shown in FIG. 1 (E). When the polarizing plate 26 is laminated on the laminate polarizing plate 10, as shown in this Figure, the polarizing plate 26 is generally laminated on the side of the first phase retarder film 11 of the laminate polarizing plate 10, but may be laminated on the side of the second phase retarder film 21, that is, outer side of the second adhesive layer 22.

To obtain circular polarizing plates, as the first phase retarder film 11, such retarder that has phase retardation value of λ/4 measured at the predetermined wavelength, for example, in a range of 540 to 560 nm of monochromatic light (this retarder is referred to as λ/4 plate hereinafter). However, when only one sheet of the λ/4 plate composed of conventional stretched resin films is employed, wavelength to obtain complete circular polarization is often restricted in a certain range. Therefore, to obtain circular polarizing in broad wavelength range, one of two methods may be employed. The first of them is that so-called broadband λ/4 plate is prepared as the first phase retarder film 11 by the combination of at least one λ/4 plate with at least one retarder plate of which retardation value is ½ wavelength measured at the predetermined wavelength, for example, in a range of 540 to 560 nm as above described monochromatic light (this retarder is referred to as λ/2 plate hereinafter), and the obtained first phase retarder film 11 is laminated on the polarizing plate 26. The second is employment of so-called inverse wavelength dispersion λ/4 plate of which retardation value is almost ¼ wavelength measured at the every wavelength within a range of 400 to 800 nm.

The first method is explained. In this method, the larger a number of the first phase retarder film is used, the broader wavelength range a circular polarization is available for. However, a larger number of the first phase retarder film results in increase of material cost and decrease of production efficiency; therefore, from the viewpoint of comparing cost with performance, a preferable circular polarizing plate may be one in which a broadband λ/4 plate formed by laminating one λ/2 plate on one λ/4 plate, is further adhered with a polarizing plate. The in-plane retardation value R_{1/2} of the λ/2 plate and the in-plane retardation value R_{1/4} of the λ/4 plate are respectively R_{1/2}=250 to 300 nm and R_{1/4}=120 to 155 nm to monochromatic light in a range of 540 to 560 nm. Moreover, R_{1/2} and R_{1/4} preferably satisfy the following correlation.
|R_{1/2}×0.5−R_{1/4}|≦10 nm

When a polarizing plate, at least one λ/2 plate and at least one λ/4 plate are laminated, the order and angle between each layer are not particularly limited as far as the performance as a circular polarization plate is achieved in wide wavelength. For example, when one λ/2 plate and one λ/4 plate are applied, one λ/2 plate and one λ/4 plate are laminated in this order and the obtained laminate is used as the first phase retarder film; and this first phase retarder film may be laminated in the order of polarizing plate/first phase retarder film/second phase retarder film, or of polarizing plate/second phase retarder film/first phase retarder film. Regarding preferable angle between each layer in this case, the following arrangements may be preferable when the angle is defined by the angle between the slow axis of the phase retarder film and the absorption axis of the polarizing plate wherein anti-clockwise direction looking from the polarizing plate is positive based on the absorption axis of the polarizing plate as baseline.
(1) λ/2 plate is between −10° to −20°, λ/4 plate is between −70° to −80°.
(2) λ/2 plate is between 70° to 80°, λ/4 plate is between 10° to 20°.
(3) λ/2 plate is between 10° to 20, λ/4 plate is between 70° to 80°.
(4) λ/2 plate is between −70° to −80°, λ/4 plate is between −10° to −20°.

The second method is explained. The inverse wavelength dispersion λ/4 described above is such that its in-plane retardation value R_{1/4} is usually 120 to 155 nm, preferably 130 to 150 nm to monochromatic light of 540 to 560 nm of wavelength; and the R_{1/4} is preferably in the above range measure at any wavelength from 400 to 800 nm. In adhering the polarizing plate and λ/4 plate, while the angle formed by the absorption axis of the polarizing plate and the slow axis of the phase retarder film, is usually 45° or 135°, the angle may be permissible as long as the performance of a circular polarizing plate is achieved within visible light wavelength. The order of layers may be in the order of polarizing plate/first phase retarder film/second phase retarder film, or of polarizing plate/second phase retarder film/first phase retarder film.

In the above explanation, when the order is polarizing plate/second phase retarder film/first phase retarder film, the polarizing plate may be laminated to the side of the second phase retarder film 21 of the laminate polarizing plate 10 as shown in FIG. 1 (E) obtained by the method of the invention, that is, outer side of the second adhesive layer 22. In this case, since a liquid crystal cell is adhered to the side of the first phase retarder film 11, another adhesive layer may be disposed at the outer side of the first phase retarder film 11.

It is also useful technology that a brightness improving film is further combined with a layered composition of a polarizing plate and a laminate polarizing plate. The brightness improving film has optical characteristics and is employed to improving brightness. The brightness improving film has a characteristics of reflecting a linear polarizing light on a pre-determined polarizing axis and a circular polarizing light in a pre-determined direction, and of transmitting polarizing lights having inverse direction against those reflected lights, among the incident natural lights coming from a backlight or a reflection plate disposed in the rear side of liquid crystal displays and the like. That is, the lights reflected by the brightness improving film are reflected in the reverse polarization state thereof on a reflective layer and the like disposed at rear side of the film, followed by again incident to the brightness improving film which allows all or most of re-incident lights to transmit therethrough, consequently, this film effectively utilizes lights and improving brightness of display devices. The examples of this film include a reflective type linear polarization dividing sheet which is designed to generate anisotropy in reflection ratio thereof by placing plural thin films having respectively different refractive index anisotropy, a circular polarization dividing sheet of stretched films of cholesteric liquid crystal polymer or film substrates supporting aligned liquid crystal layer, and the like.

Diffusion adhesives may be applied to the interface where the laminate polarizing plate contacts with a liquid crystal cell. The diffusion adhesive is an adhesive containing fine particles capable of scattering light. The fine particles used are not particularly limited as long as having capability of light scattering, and any of organic particles and inorganic particles may be used. The organic particles include, for example, particles of high molecule substances such as polyolefin resins like polystyrene, polyethylene and polypropylene, and acrylic resin; crosslinked polymers may be also used. Furthermore, copolymers of at least two kinds of monomers selected from ethylene, propylene, styrene, methyl methacrylate, benzoguanamine, formaldehyde, melamine, butadiene and the like, may be also used. The inorganic particles include, for example, silica, silicone, titanium oxide and the like, glass beads are also available. These fine particle are preferably colorless or white, and colored fine particles may be used for decorating.

The shape of fine particles is also not particularly limited, and the preferable includes sphere form, spindle form or a form like cube. Regarding particle diameter, if this is too small, the light scattering characteristics thereof may not be sufficient, if being too large, visual quality of liquid crystal displays applied therewith may be deteriorated, consequently, the preferable particle diameter is equal to or more than 0.5 μm and equal to or less than 20 μm, the more preferable is equal to or more than 1 μm and equal to or less than 10 μm. The fine particles may be added in an amount appropriately determined according to the scale of light scattering ability desired, and usually blended in a ratio equal to or more than 0.01 parts by weight and equal to or less than 100 parts by weight based on 100 parts by weight of adhesive as a dispersing media, preferably equal to or more than 1 parts by weight and equal to or less than 50 parts by weight.

The adhesives used for diffusion adhesives are not particularly limited, known adhesives such as the acrylic adhesives, the vinyl chloride adhesives, the synthetic rubber adhesives and the like, may be used. When such diffusion adhesives are disposed between the laminate polarizing plate and a liquid crystal cell, the diffusion adhesives may be applied to the aforementioned second adhesive layer (the sign 22 in FIG. 1 (E)).

When a laminate polarizing plate obtained by the present invention is used for liquid crystal displays, constitution examples of a circular polarizing plate employing the laminate polarizing plate are listed below. The preferable combination is selected in view of performance and cost of the obtained liquid crystal displays. For example, if a liquid crystal cell is a reflection type, the laminate polarizing plate is laminated on at only front side of liquid crystal cell, if a liquid crystal cell is a semi-transmission reflection type, the laminate polarizing plate is laminated on at both of the front and rear sides; and if a liquid crystal cell is a transmission type, the laminate polarizing plate is laminated on at either of the front sides or rear side.

1. Constitution Examples of the Front Side in the Case of a Liquid Crystal Cell Being the Reflection Type

(1) polarizing plate/adhesive/first phase retarder film (λ/4 plate)/adhesive/second phase retarder film/adhesive/front face of liquid crystal cell
(2) polarizing plate/adhesive/first phase retarder film (inverse wavelength dispersion λ/4 plate)/ adhesive/second phase retarder film/adhesive/front face of liquid crystal cell
(3) polarizing plate/adhesive/first phase retarder film (λ/2 plate+λ/4 plate)/adhesive/second phase retarder film/adhesive/front face of liquid crystal cell
(4) polarizing plate/adhesive/first phase retarder film (λ/4 plate)/adhesive/second phase retarder film/diffusion adhesive/front face of liquid crystal cell
(5) polarizing plate/adhesive/first phase retarder film (inverse wavelength dispersion λ/4 plate)/ adhesive/second phase retarder film/diffusion adhesive/front face of liquid crystal cell
   2. Constitution Examples of the Front Side in the Case of the Semi-Transmission Reflection Type
(1) polarizing plate/adhesive/first phase retarder film (λ/4 plate)/adhesive/second phase retarder film/adhesive/front face of liquid crystal cell
(2) polarizing plate/adhesive/first phase retarder film (inverse wavelength dispersion λ/4 plate)/ adhesive/second phase retarder film/adhesive/front face of liquid crystal cell
(3) polarizing plate/adhesive/first phase retarder film (λ/2 plate+λ/4 plate)/ adhesive/second phase retarder film/adhesive/front face of liquid crystal cell
(4) polarizing plate/adhesive/first phase retarder film (λ/4 plate)/adhesive/second phase retarder film/diffusion adhesive/front face of liquid crystal cell
(5) polarizing plate/adhesive/first phase retarder film (inverse wavelength dispersion λ/4 plate)/ adhesive/second phase retarder film/diffusion adhesive/front face of liquid crystal cell
(6) polarizing plate/adhesive/first phase retarder film (λ/2 plate+λ/4 plate)/ adhesive/second phase retarder film/diffusion adhesive/front face of liquid crystal cell
   3. Constitution Examples of the Rear Side in the Case of the Semi-Transmission Reflection Type
(1) polarizing plate/adhesive/first phase retarder film (λ/4 plate)/adhesive/second phase retarder film/adhesive/back face of liquid crystal cell
(2) polarizing plate/adhesive/first phase retarder film (inverse wavelength dispersion λ/4 plate)/ adhesive/second phase retarder film/adhesive/back face of liquid crystal cell
(3) polarizing plate/adhesive/first phase retarder film (λ/2 plate+λ/4 plate)/ adhesive/second phase retarder film/adhesive/back face of liquid crystal cell
(4) brightness enhanced film/polarizing plate/adhesive/first phase retarder film (λ/4 plate)/ adhesive/second phase retarder film/diffusion adhesive/back face of liquid crystal cell
(5) brightness enhanced film/polarizing plate/adhesive/first phase retarder film (inverse wavelength dispersion λ/4 plate)/ adhesive/second phase retarder film/diffusion adhesive/back face of liquid crystal cell
(6) brightness enhanced film/polarizing plate/adhesive/first phase retarder film (λ/2 plate+λ/4 plate)/ adhesive/second phase retarder film/diffusion adhesive/back face of liquid crystal cell
   4. Constitution Examples of the Front Side in the Case of the Transmission Type
(1) polarizing plate/adhesive/first phase retarder film/adhesive/second phase retarder film/adhesive/front face of liquid crystal cell
   5. Constitution Examples of the Rear Side in the Case of the Transmission Type
(1) polarizing plate/adhesive/first phase retarder film/adhesive/second phase retarder film/adhesive/back face of liquid crystal cell
(2) brightness enhanced film/polarizing plate/adhesive/first phase retarder film/adhesive/second phase retarder film/adhesive/back face of liquid crystal cell

The present invention can produce with favorable quality and low cost a laminate polarizing plate in which a first monoaxially or biaxially oriented phase retarder film including transparent resin film, is laminated on a second phase retarder film including a coating layer having refractive index anisotropy; and an optical member in which an other optical layer such as polarizing plates, is laminated on the laminate polarizing plate. The present invention can advantageously produce a laminate polarizing plate and a optical member; since the process for drying the second phase retarder film including a coating layer, is not required to be carried out on the first phase retarder film, this allows to avoid, for example, degradation or retardation value deterioration of the first phase retarder film due to heat effect, and to avoid insufficiently drying the second phase retarder film.

### EXAMPLE

The present invention is explained in more detail referring Examples, but should not be limited thereto. In the Examples, the term of % representing amount contained or used is based on weight as far as without particular remarks. The materials used for forming coating layers in the following Examples are as follows.

(A) Organic Modified Clay Composite

Trade name “Lucentite STN”: manufactured by CO—OP Chemical, which is the composite of the synthetic hectorite and the quaternary ammonium compound, and superior in dispersiblity to a high polar solvent.

Trade name “Lucentite SPN”: manufactured by CO—OP Chemical, which is the composite of the synthetic hectorite and the quaternary ammonium compound, and superior in dispersiblity to a non-polar solvent.

(B) Binder

Trade name “Arontack S1601”: manufactured by TOAGOSEI Co., Ltd., Acrylic resin varnish

Measurement and evaluation of the physical properties of samples were carried out according to the following methods.

(1) In-Plane Retardation Value R₀

The coating layer formed on the transfer substrate was transferred to the glass plate of 4 cm square interposing the adhesive. The measurement was carried out in the state affixed on the glass plate by “KOBRA-21 ADH” manufactured by Oji Scientific Instruments about the in-plane retardation value R₀ with the rotary analyzer method using monochromatic light of 559 nm wave length. The in-plane retardation value R₀ of the phase retarder film made of an elongated resin film was directly measured by “KOBRA-21 ADH” described above.

(2) Retardation Value in the Thickness Direction R′

By using the in-plane retardation value R₀, the retardation value R₄₀ measured in 40° aslant state by applying the in-plate slow axis as the inclined axis, the film thickness d and the average refractive index of film n₀, the nₓ, n_{y} and n_{z} were obtained from the aforementioned method, followed by calculation of the retardation value in the thickness direction R′ according to the formula (II) described above.

### Example 1

The coating solution was prepared in the following composition.

| | |
|---|---|
| Acrylic resin varnish “Arontack S1601” | 10.2% |
| Organic modified clay composite “Lucentite STN” | 6.75% |
| Organic modified clay composite “Lucentite SPN” | 2.25% |
| Toluene | 45.6% |
| Acetone | 35.2% |

The prepared coating solution was consecutively coated by a die coater on the polyethylene terephthalate film of 38 μm thickness which had been subjected to mould releasing treatment (the water contact angle at the face of mould releasing treatment was 110°), followed by being subjected to drying during passing through a drying oven; then the coating layer (second phase retarder film) was, at a time just passed out from the oven, consecutively adhered on the exposed surface thereof with the adhesive side of the λ/4 plate (first phase retarder film, trade name of “Sumikalight SES440138” manufactured by Sumitomo Chemical, R₀=138 nm) which is a stretched cyclic polyolefin resin and has an adhesive layer on the one side thereof, and then the adhered film was rolled in a roll to produce a semi-finished product having a layer structure of first phase retarder film/adhesive layer/second phase retarder film/release film. Sample was taken out before the coating layer being subjected to adhere with the λ/4 plate, in order to measure the phase retardation value thereof, the measurement results were R₀=0 nm and R′=115 nm, and the water contact angle at the air exposed surface being 81°.

Thereafter, the semi-finished product was unrolled out, and then, along with peeling the release film away, the surface of coating layer from which the release film was peeled off, was consecutively adhered with the adhesive side of the polyethylene terephthalate film which was separately coated with an adhesive on mould releasing treatment surface thereof, to obtain a laminate polarizing plate having a layer structure of first phase retarder film/adhesive layer/second phase retarder film/adhesive layer/release film. The water contact angle of the surface of the coating layer of the semi-finished product after being peeled off from the release film, was 88°.

A polyvinylalcohol-iodine polarizer (trade name of “SUMIKARAN SRW842A”, manufactured by Sumitomo Chemical) which has an adhesive layer at one side thereof, was separately prepared, and the prepared polarizer was adhered with the laminate polarizing plate obtained above in a disposition manner that the angle formed by the slow axis of the laminate polarizing plate and the absorption axis of the polarizer, was 45°, and the adhesive layer of the polarizer was faced to the first phase retarder film of the laminate polarizing plate described above to produce 100 sheets of the circular polarizing plate having 2 inches (38.2 mm×30.7 mm) of width across corner. The circular polarizing plates were inspected; consequently, defects such as phase retardation irregularities, air bubbles left in adhered parts or the like, were almost not observed therein; the high quality laminate polarizing plate was easily obtained in 96% of yield.

### Comparative Example 1

The same coating solution used in the Example 1 was consecutively coated by a die coater under the same conditions applied in the Example 1, on the polyethylene terephthalate film of 38 μm thickness which is subjected to mould releasing treatment, followed by being subjected to drying during passing through a drying oven; then the coated layer was, at a time just passed out from the oven, adhered on the exposed surface thereof with the protective film, followed by being rolled in. Thereafter, the layered composition having a layer structure of release film/coating layer/protecting film, was cut in the size of 2 inches (38.2 mm×30.7 mm) of width across corner; then the protecting film was peeled off from the cut-out layered composition; and then the λ/4 plate having an adhesive layer on one side thereof, which was the same applied in Example 1, was separately cut in the same shape; then thus prepared sheets were disposed in a manner of facing the coating layer of the layered composition toward the adhesive layer of the λ/4 plate, followed by adhering each other by an affixation device to obtain a laminate polarizing plate. The laminate polarizing plate was adhered with the polarizing plate applied in Example 1 in the same manner employed therein to obtain a circular polarizing plate. 100 sheets of the circular polarizing plate were produced; 35 sheet of them had favorable qualities, but 65 sheets generated phase retardation irregularities, air bubbles left in adhered parts, spotted foreign objects, linear foreign objects and the like. Although much labor was consumed for preparation in comparison with Example 1, the resultant quality was poor.

1. A method for producing a laminate polarizing plate comprising a first phase retarder film and a second phase retarder film, wherein the first phase retarder film comprises an in-plane oriented transparent resin film having an adhesive layer on its surface, the second phase retarder film has at least one coating layer with refractive index anisotropy, and the second phase retarder film is on the adhesive layer, the method comprising:
a first step of forming the coating layer on a transfer substrate, followed by laminating an opposite surface of the coating layer to the transfer substrate on the adhesive layer of the first phase retarder film; and
a second step of peeling the transfer substrate from the coating layer along with forming a second adhesive layer on the surface of the coating layer from which the transfer substrate has been peeled.

2. The method according to claim 1, wherein the first phase retarder film is a ¼ wavelength retarder plate.

3. The method according to claim 1, wherein at least one layer of the coating layers having refractive index anisotropy comprises at least one selected from a liquid crystalline compound and a cured liquid crystalline compound.

4. The method according to claim 1, wherein at least one layer of the coating layers having refractive index anisotropy comprises a layer containing an organic modified clay composite which is capable of dispersing in an organic solvent.

5. The method according to claim 4, wherein the layer containing the organic modified clay composite contains a binder comprising a resin having glass transition temperature equal to or less than a room temperature, in addition to said organic modified clay composite.

6. The method according to claim 1, wherein the transfer substrate has a mould-releasing treated surface, wherein a water contact angle of the mould releasing treated surface is 90 to 130°.

7. The method according to claim 1, wherein the second adhesive layer is applied in the second step under the condition that an increase of a water contact angle of the coating layer surface after the transfer substrate is peeled off, is not more than 15° in comparison with a water contact angle of the exposed surface of the formed coating layer.

8. A method for producing an optical member, wherein the method includes: preparing the first phase retarder film comprising an in-plane oriented transparent resin film having an adhesive layer on its surface;
separately preparing a second phase retarder film by forming at least one coating layer having refractive index anisotropy on a transfer substrate;
laminating an opposite surface of the coating layer to the transfer substrate on the adhesive layer of the first phase retarder film; followed by peeling the transfer substrate from the coating layer along with forming a second adhesive layer on the surface of the coating layer from which the transfer substrate has been peeled;
to produce a laminate polarizing plate having layers of first phase retarder film/adhesive layer/second phase retarder film/second adhesive layer and,
thereafter laminating an optical layer which exhibits another optical function, on the laminate polarizing plate.

9. The method according to claim 8, wherein the optical layer exhibiting another optical function is a polarizing film, wherein the polarizing film is laminated on a side of the first phase retarder film of the laminate polarizing plate.

10. The method according to claim 2, wherein at least one layer of the coating layers having refractive index anisotropy comprises at least one selected from a liquid crystalline compound and a cured liquid crystalline compound.

11. The method according to claim 2, wherein at least one layer of the coating layers having refractive index anisotropy comprises a layer containing an organic modified clay composite which is capable of dispersing in an organic solvent.

12. The method according to claim 11, wherein the layer containing the organic modified clay composite contains a binder comprising a resin having glass transition temperature equal to or less than a room temperature, in addition to said organic modified clay composite.

13. The method according to claim 2, wherein the transfer substrate has a mould-releasing treated surface, wherein a water contact angle of the mould releasing treated surface is 90 to 130°.
